(19) United States
(12) Patent Application Publication
(10) Pub. No.: US 2007/0193850 A1
(43) Pub. Date: Aug. 23, 2007

(54) Clutch housing with openings to engage a clutch plate

(75) Inventors: Todd Sturgin, Shreve, OH (US); Adam Uhler, Sterling, OH (US); Philip George, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/706,661

(22) Filed: Feb. 15, 2007

Related U.S. Application Data
(60) Provisional application No. 60/775,622, filed on Feb. 22, 2006.
(60) Provisional application No. 60/775,619, filed on Feb. 22, 2006.
(60) Provisional application No. 60/775,620, filed on Feb. 22, 2006.
(60) Provisional application No. 60/775,621, filed on Feb. 22, 2006.
(60) Provisional application No. 60/775,623, filed on Feb. 22, 2006.

(51) Int. Cl. F16D 3/14

(52) U.S. Cl. 192/212

(57) ABSTRACT

The present invention broadly comprises a clutch housing with a housing wall disposed radially about a longitudinal axis for the housing and at least one opening in the housing wall operatively arranged to accept at least a portion of a clutch plate for a clutch assembly. The housing is substantially cylindrical and in some aspects the openings are slots substantially parallel to the axis. In some aspects, the housing wall further comprises an end and the at least one slot has an open end proximate the end or the housing wall further comprises a radial off-set proximate the end. In some aspects, the clutch housing is an inner housing or an outer housing for the clutch assembly.

### CROSS-REFERENCE TO RELATED APPLICATIONS

This application claims the benefit under 35 U.S.C. §119(e) of U.S. Provisional Application No. 60/775,622 filed Feb. 22, 2006; U.S. Provisional Application No. 60/775,619 filed Feb. 22, 2006; U.S. Provisional Application No. 60/775,620 filed Feb. 22, 2006; U.S. Provisional Application No. 60/775,621 filed Feb. 22, 2006; and U.S. Provisional Application No. 60/775,623 filed Feb. 22, 2006.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to a clutch housing for transmitting torque from the driving unit to clutch plates in a clutch assembly. Specifically, the invention relates openings in the housing to engage the clutch plates.

### BACKGROUND OF THE INVENTION

Commonly assigned, and therefore, uncitable, United States Patent Application No. 2005/0139442 filed Dec. 23, 2004 and published Jun. 30, 2005, which application is incorporated herein by reference, shows an example of the use a clutch housing in a clutch assembly of a vehicle to transmit torque from the vehicle engine to clutch plates in the clutch assembly. The housing is connected in some manner to the crankshaft of the engine and the housing is configured to engage the clutch plates. For example, a drum-shaped housing with a substantially cylindrical portion having an inner surface (facing a longitudinal axis for the clutch assembly) can be used. Splines are formed on the inner surface to engage at least some of the clutch plates. The remaining clutch plates are typically connected to an output for the clutch assembly. Fluid pressure in the clutch assembly is manipulated to engage the clutch plates so that the plates on the splines engage the plates connected to the output. Thus, torque is transferred from the engine to the clutch plates. Roll forming is used to form the splines. Roll forming is a relatively costly tooling process, at least due to the requirement of additional stations in the process. Thus, a clutch assembly could be improved by using a less expensive method for producing the housing.

Thus, there is a long-felt need for a clutch housing that can be quickly and inexpensively manufactured. Further, there is a long-felt need for a simplified means of assembling a clutch housing and clutch plates in a clutch assembly.

### BRIEF SUMMARY OF THE INVENTION

The present invention broadly comprises a clutch housing with a substantially cylindrical housing wall and at least one opening in the housing wall operatively arranged to accept at least a portion of a clutch plate for a clutch assembly. In some aspects, the openings are slots substantially parallel to a longitudinal axis for the housing. In some aspects, the housing wall further comprises an end and the at least one opening is in communication with the end or the housing wall further comprises a radial off-set proximate the end. In some aspects, the clutch housing is an inner housing or an outer housing for the clutch assembly. In some aspects, the housing is stamped or machined.

The present invention also broadly comprises a clutch assembly with a clutch housing having at least one opening and at least a portion of a clutch plate disposed in the at least one opening. The clutch housing further comprises a cylindrically-shaped housing wall, the at least one opening is disposed in the housing wall, and in some aspects, the at least one opening is at least one slot aligned substantially parallel to an axis for the housing. The housing wall comprises an edge proximate at least a portion of the at least one opening and the clutch housing is arranged so that the portion of the clutch plate contacts the edge when torque is applied to the clutch housing. In some aspects, the clutch housing is an inner housing or an outer housing for the clutch assembly.

The present invention further broadly comprises a dual clutch assembly, including an outer clutch housing having at least one first opening and an inner clutch housing having at least one second opening. The inner housing is fastened to the outer housing and the at least one first and second openings are operatively arranged to accept at least a portion of first and second clutch plates, respectively, for a clutch assembly.

The present invention also broadly comprises a method of transferring torque from a clutch housing to a clutch plate.

It is a general object of the present invention to provide a clutch housing, a clutch assembly, and a dual clutch assembly minimizing the number of manufacturing steps involved in fabricating the housing, in particular, minimizing the number of die stations used.

It is another object of the present invention to provide a clutch housing, a clutch assembly, and a dual clutch assembly that can be manufactured without the use of roll forming.

It is yet another object of the present invention to provide a clutch housing, a clutch assembly, and a dual clutch assembly that can be made of stamped components.

It is a further object of the present invention to provide a clutch housing, a clutch assembly, and a dual clutch assembly that can be made of machined components.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a present invention outer clutch housing;

FIG. 2 is a perspective view of a present invention inner clutch housing;

FIG. 3 is a perspective view of a dual clutch assembly with spring plates removed and including the clutch housings of FIGS. 1 and 2;

FIG. 4 is a bottom view of the assembly of FIG. 3;

FIG. 5 is an exploded cross-sectional view of the outer housing and respective clutch plates of FIG. 4 along line 5,7-5,7 in FIG. 4;

FIG. 6 is a cross-sectional view of the outer housing and respective clutch plates of FIG. 5;

FIG. 7 is a cross-sectional view of the inner housing of FIG. 4 along line 5,7-5,7 in FIG. 4;

FIG. 8 is an cross-sectional view of the inner housing and respective clutch plates of FIG. 4 along line 7-7 in FIG. 4;

FIG. 9 is a perspective view of a present invention dual clutch assembly;

FIG. 10 is an exploded view of the assembly of FIG. 9;

FIG. 11 is a side view of the assembly of FIG. 9;

FIG. 12 is a perspective view of a present invention outer clutch housing;

FIG. 13 is a perspective view of a present invention inner clutch housing;

FIG. 14 is a perspective view of a dual clutch assembly with spring plates removed and including the clutch housings of FIGS. 14 and 15;

FIG. 15 is a bottom view of the assembly of FIG. 16;

FIG. 16 is a partial cross-sectional view of the inner housing and respective clutch plates of FIG. 15 along line 16-16 in FIG. 15;

FIG. 17 is an exploded view of a present invention dual clutch assembly; and,

FIG. 18 is a side view of the assembly of FIG. 17.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

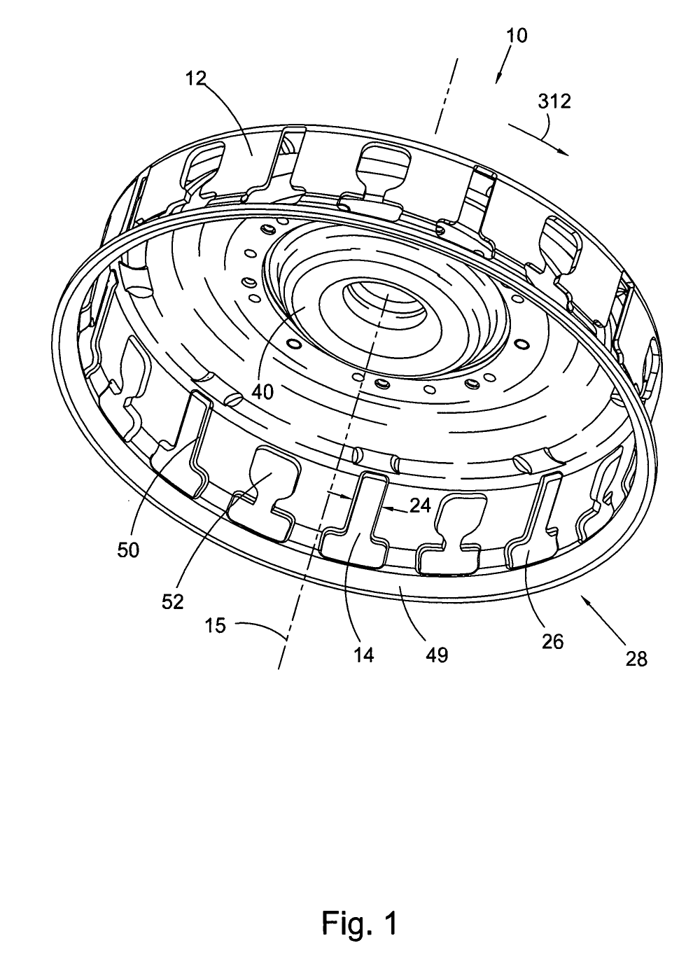

FIG. 1 is a perspective view of present invention outer clutch housing 10.

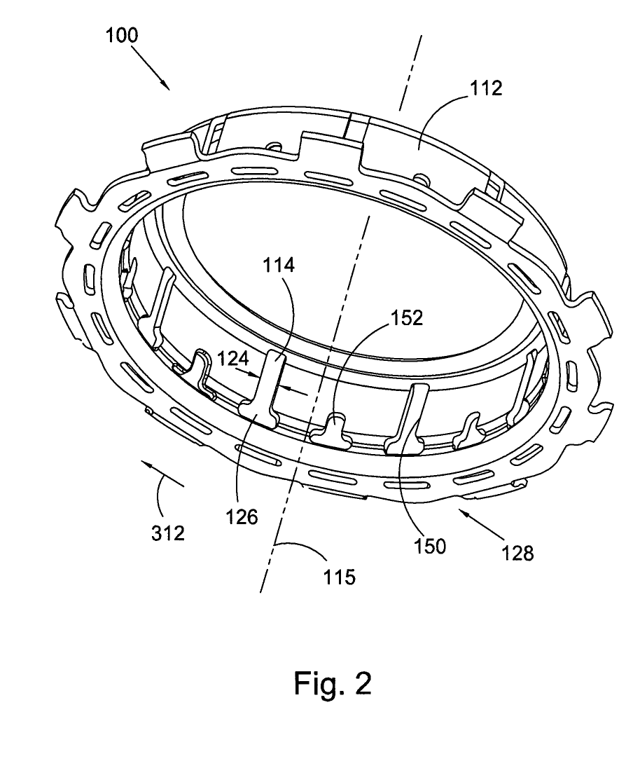

FIG. 2 is a perspective view of present invention inner clutch housing 100.

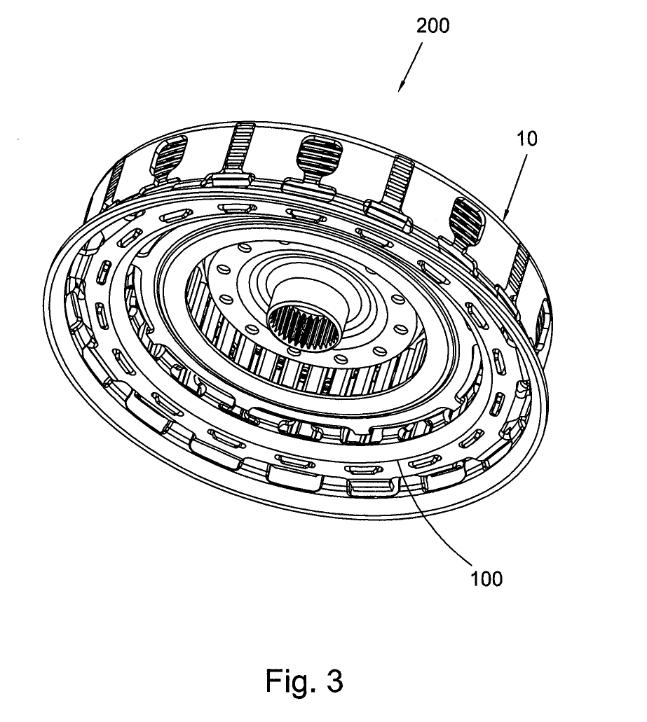

FIG. 3 is a perspective view of dual clutch assembly 200 with spring plates removed and including the clutch housings of FIGS. 1 and 2.

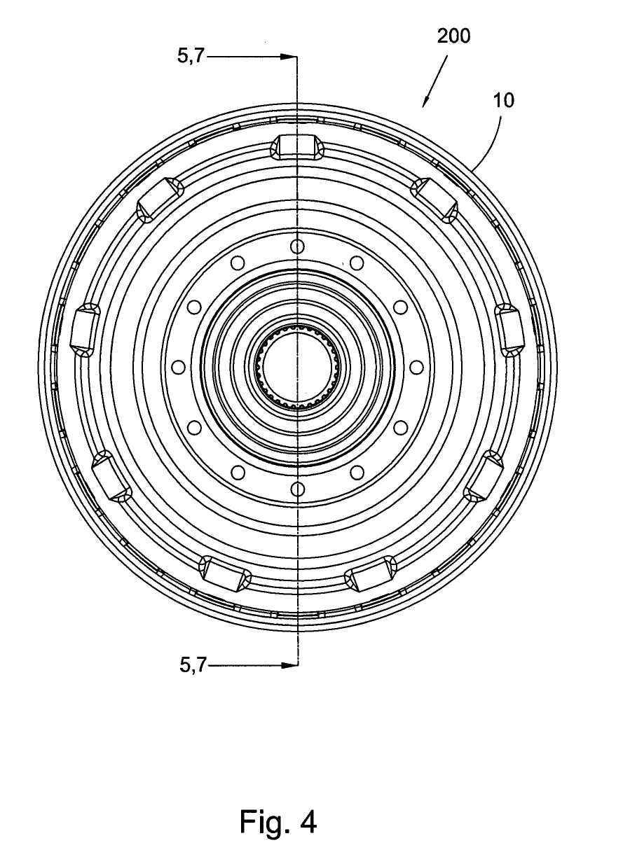

FIG. 4 is a bottom view of the assembly of FIG. 3.

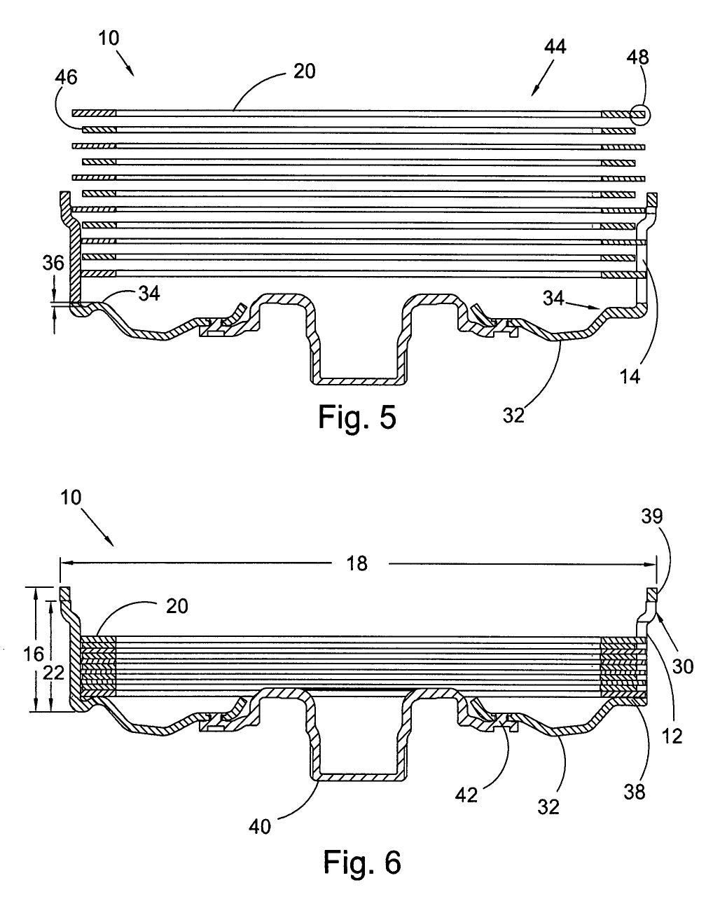

FIG. 5 is an exploded cross-sectional view of the outer housing and respective clutch plates of FIG. 4 along line 5,7-5,7 in FIG. 4.

FIG. 6 is a cross-sectional view of the outer housing and respective clutch plates of FIG. 5. The following should be viewed in light of FIGS. 1 and 3 through 6. In FIG. 1, clutch housing 10 includes housing wall 12, slots 14 in wall 12, and longitudinal axis 15. Wall 12 is disposed radially about axis 15. That is, in general, wall 12 is cylindrical in shape. However, it should be understood that wall 12 is not limited to the shape shown in the figures and that other shapes for wall 12 are included within the spirit and scope of the invention as claimed. For example, wall 12 is not limited to a particular height 16 or diameter 18.

As shown in FIGS. 1, 5, and 6, slots 14 are arranged to accept clutch plates 20 from a clutch assembly. That is, at least a portion of plates 20 are disposed within slots 14. Slots 14 are not limited to the shape shown in the figures. Other shapes for slots 14 are possible and are included within the spirit and scope of the invention as claimed. For example depth 22 and width 24 of slots 14 can be varied. Also, housing 10 is not limited to the number of slots 14 shown.

Slots 14 include openings 26 at end 28 of wall 12. The openings are provided to enable plates 20 to be inserted into slots 14 without bending or distorting the plates. In some aspects, wall 12 includes radial offset 30, which enables plates 20 to be inserted into the slots through openings 26.

End wall 32 is arranged so that plates 20 contact the wall. In some aspects, clutch plate stop 34 is formed in wall 32 to engage plates 20. Stop 34 extends distance 36 above wall 32, forming slot 38 between plates 20 and wall 32. In some aspects, due to clearance and access requirements for the equipment forming slots 14, stop 34 is only formed in those portions of wall 32 not in radial alignment with slots 14. Wall 32 is shown as integral to wall 12, however, it should be understood that other configurations of walls 12 and 32 are possible. Also, other cross-sectional shapes and configurations for wall 32 are possible.

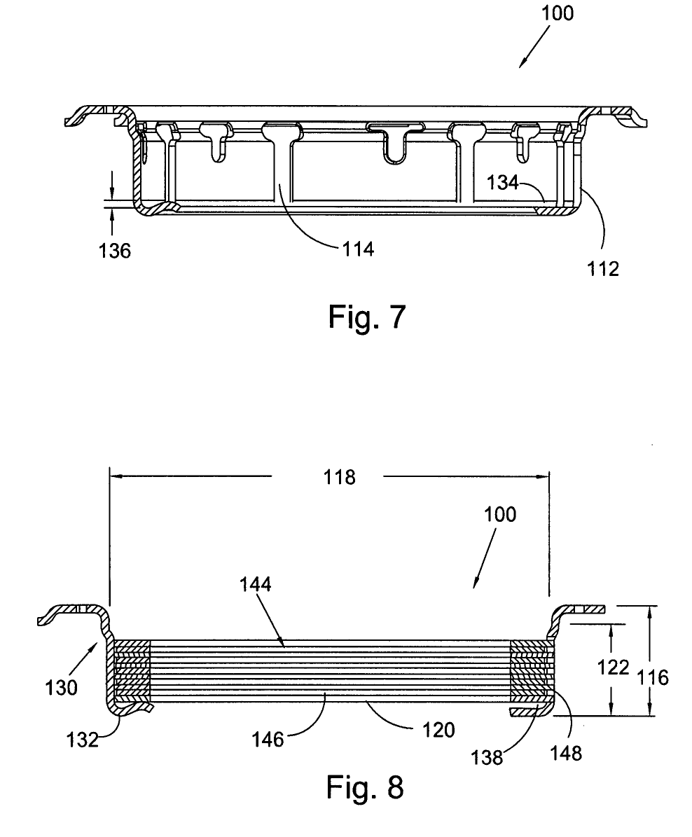

FIG. 7 is a cross-sectional view of the inner housing of FIG. 4 along line 5,7-5,7 in FIG. 4.

FIG. 8 is an cross-sectional view of the inner housing and respective clutch plates of FIG. 4 along line 5,7-5,7 in FIG. 4. The following should be viewed in light of FIGS. 1-8. In FIG. 2, clutch housing 100 includes housing wall 112, slots 114 in wall 112, and a longitudinal axis 115. Wall 112 is disposed radially about axis 115. That is, in general, wall 112 is cylindrical in shape. However, it should be understood that wall 112 is not limited to the shape shown in the figures and that other shapes for wall 112 are included within the spirit and scope of the invention as claimed. For example, wall 112 is not limited to a particular height 116 or diameter 118.

As shown in FIGS. 2, 7, and 8, slots 114 are arranged to accept clutch plates 120 from a clutch assembly. That is, at least a portion of plates 120 are disposed within slots 114. Slots 114 are not limited to the shape shown in the figures. Other shapes for slots 114 are possible and are included within the spirit and scope of the invention as claimed. For example, depth 122 and width 124 of slots 114 can be varied. Also, housing 100 is not limited to the number of slots 114 shown.

Slots 114 include openings 126 at end 128 of wall 112. The openings are provided to enable plates 120 to be inserted into slots 114 without bending or distorting the plates. In some aspects, wall 112 includes radial offset 130, which enables plates 120 to be inserted into the slots through openings 126.

End wall 132 is arranged so that plates 120 contact the wall. In some aspects, clutch plate stop 134 is formed in wall 132 to engage plates 120. Stop 134 extends a distance 136 above wall 132, forming slot 138 between plates 120 and wall 132. Wall 132 is shown as integral to wall 112, however, it should be understood that other configurations of walls 112 and 132 are possible. Also, other cross-sectional shapes and configurations for wall 132 are possible.

Returning to FIG. 1, in some aspects, housing 10 includes hub 40. End wall 32 extends to hub 40 and in some aspects; end wall 32 is connected to the hub using extruded rivets 42, a relatively cost-effective process. However, it should be understood that other methods, such as separate rivets or mechanical fasteners, or welding, can be used to secure end wall 32 to hub 40. In some aspects, torque from a drive unit is transmitted to housing 10 via hub 40.

FIGS. 5 and 6 illustrate the stacking of plates 20 in housing 10. FIG. 5 is an exploded view showing outer clutch plate pack 44, including alternating plates 20 and plates 46. It should be understood that the present invention is not limited to use with any particular number of plates 20 and 46 or any particular configuration of pack 44. Tabs 48 extend from the outer circumference of plates 20 and are received in slots 14. In general, tabs 48 correspond in number, location, shape, and configuration to slots 14. That is, each tab 48 corresponds to a respective slot 14. However, it should be understood that other configurations of slots are included within the spirit and scope of the invention as claimed.

FIGS. 7 and 8 illustrate the stacking of plates 120 in housing 100. FIG. 8 shows inner clutch plate pack 144 including alternating plates 120 and plates 146. It should be understood that the present invention is not limited to use with any particular number of plates 120 and 146 or any particular configuration of pack 144. Tabs 148 extend from the outer circumference of plates 120 and are received in slots 114. In general, tabs 148 correspond in number, location, shape, and configuration to slots 114. That is, each tab 148 corresponds to a respective slot 114. However, it should be understood that other configurations of slots are included within the spirit and scope of the invention as claimed.

The following should be viewed in light of FIGS. 1 through 8. Although in general, two or more slots 14 or 114 are preferred, any number of slots 14 or 114 is possible and such number of slots is included within the spirit and scope of the invention as claimed. Also, the present invention is not limited to any particular configuration or spacing of slots 14 or 114. In general, walls 12 and 112 and slots 14 and 114, respectively are parallel to axis 15 and 115, respectively. It should be understood that the present invention is not limited to use with the number and configuration of plates 20, 46, 120, or 146 shown in the figures. That is, other numbers and configurations of plates can be used with the present invention.

Housings 10 and 100 are stamped, reducing fabricating cost and complexity. However, it should be understood that other fabrication methods can be used to form housings 10 or 100. In some aspects, walls 12 and 112 are pierced after the forming process to create slots 14 and 114, respectively, eliminating the need for roll forming, with its attendant complexities and costs. Also, since the slots are made after the forming process, potential deformation and dimensional variation are reduced. Housing 10 also is formed with lip 49, which provides continuous support about edge 28 of housing 10, in particular providing support to resist the hoop stresses to which housing 10 is subjected during use. In some aspects, due to clearance and access requirements for the equipment forming slots 14, lip 49 is formed after slots 14 are pierced.

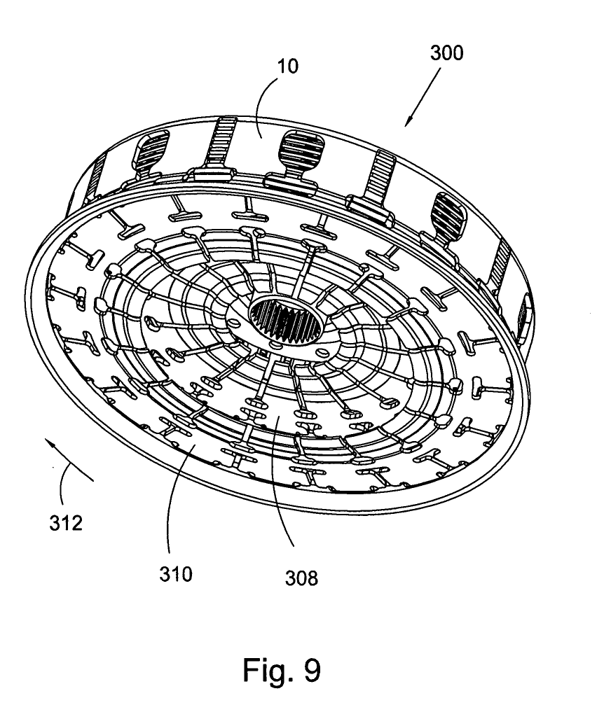

FIG. 9 is a perspective view of present invention dual clutch assembly 300.

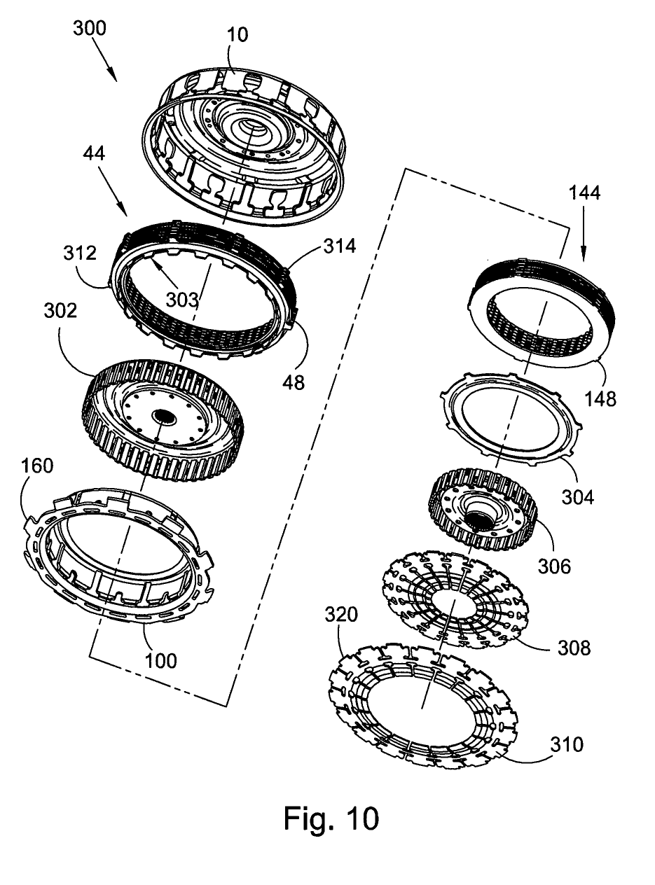

FIG. 10 is an exploded view of the assembly of FIG. 9. The following should be viewed in light of FIGS. 1 through 10. To form assembly 300, pack 44 is stacked in housing 10 and carrier ring 302 and fulcrum 303 are engaged to housing 10. Pack 144 is stacked in housing 100 and flow dam 304 and carrier ring 306 are engaged to housing 100. Housing 100 is engaged to housing 10, plate spring 308 is installed to engage pack 144, and plate spring 310 is installed to engage pack 44. However, it should be understood that the present invention is not limited to use with the number, type, and configuration of components shown in FIG. 10 and other number, type, and configuration of components can be used with the present invention.

Springs 310 and 308 can be engaged with housing 10 and 100, respectively, using any means known in the art. In addition, in some aspects, an arrangement of spring tabs and slots in the housing as described in the commonly assigned United States Provisional Patent Application titled “CLUTCH HOUSING WITH LEVER SPRING RETENTION SLOTS AND METHOD OF INSTALLING A LEVER SPRING,” inventors Todd Sturgin and Adam Uhler, filed on the same day as the present application, can be used. For example, tabs 320 of spring 310 engage openings 26 in housing 10.

It should be understood that any means known in the art, for example, complimentary splines and notches or welding, can be used to connect housing 10 to housing 100. In addition, in some aspects, a tab and slot arrangement as described in the commonly assigned United States Provisional Patent Application titled “CLUTCH HOUSING WITH WIDE LEVER SPRING RETENTION SLOTS AND CLUTCH HOUSING WITH AXIALLY OFF-SET TABS,” inventor Adam Uhler, filed on the same day as the present application, can be used. For example, tabs 160 engage with openings 26 in housing 100 to rotationally lock clutch housing 10 with housing 100.

When torque is applied to hub 40 in direction 312, housing 10 moves in direction 312 and housing 10, in particular, wall 12, engages plates 20. Specifically, edges 50 of slots 14, formed by a portion of wall 12, engage edges 314 of tabs 48, rotating plates 20 in direction 312. The torque is transferred to housing 100. In like manner, edges 150 of slots 114 engage tabs 148, rotating plates 120 in direction 312. In a neutral state (no external pressure is applied to springs 308 and 310), plates 20 and 46 and 120 and 146, respectively, are not engaged. For example, plates 20 are free to rotate with minimal or no contact with plates 46. When force is applied to spring 310, plates 20 and 46 are brought into frictional contact and rotate together, transferring the torque to carrier ring 302. When force is applied to spring 308, plates 120 and 146 are brought into frictional contact and rotate together, transferring the torque to carrier ring 306. In some aspects, additional slots in housings 10 and 100, for example slots 52 and 152, respectively, are included to provide passage of cooling fluids and to engage spring tabs. It should be understood that assembly 300 also can be moved in a direction opposite direction 312.

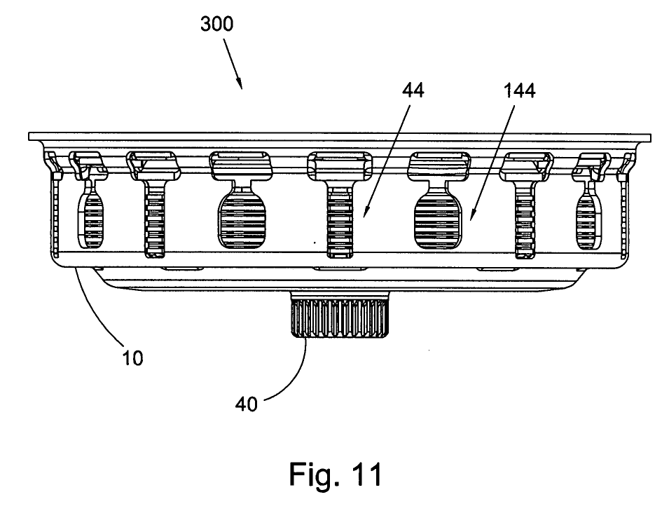

FIG. 11 is a side view of the assembly of FIG. 9.

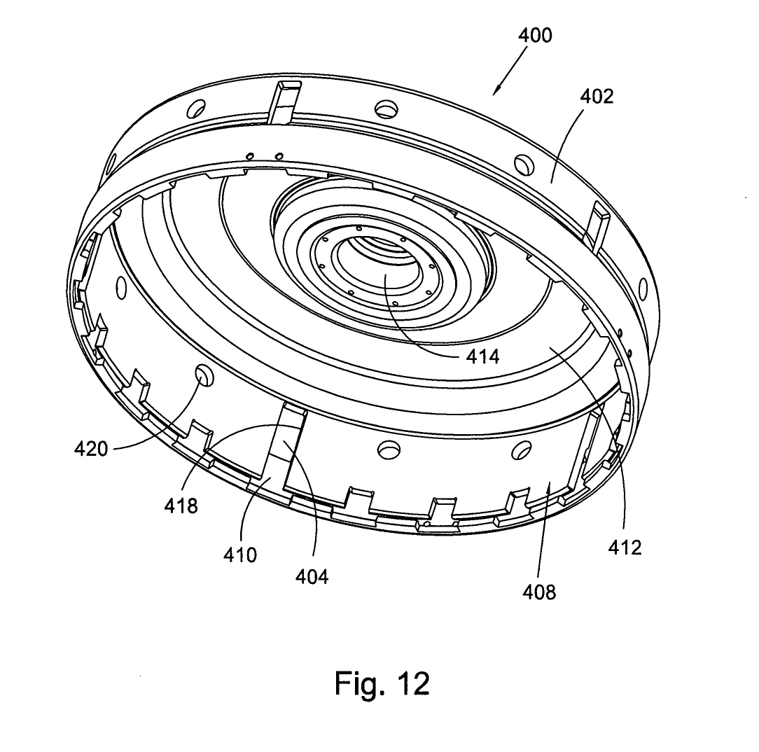

FIG. 12 is a perspective view of present invention outer clutch housing 400.

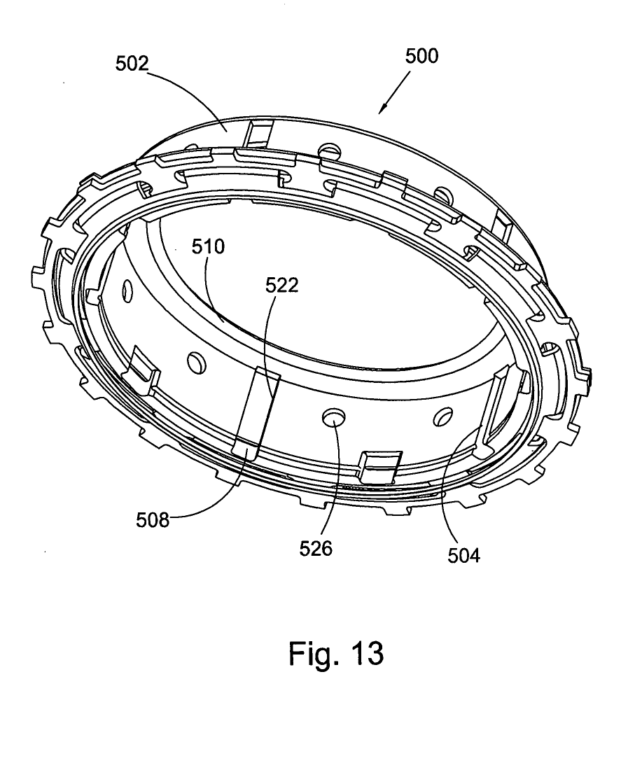

FIG. 13 is a perspective view of present invention inner clutch housing 500.

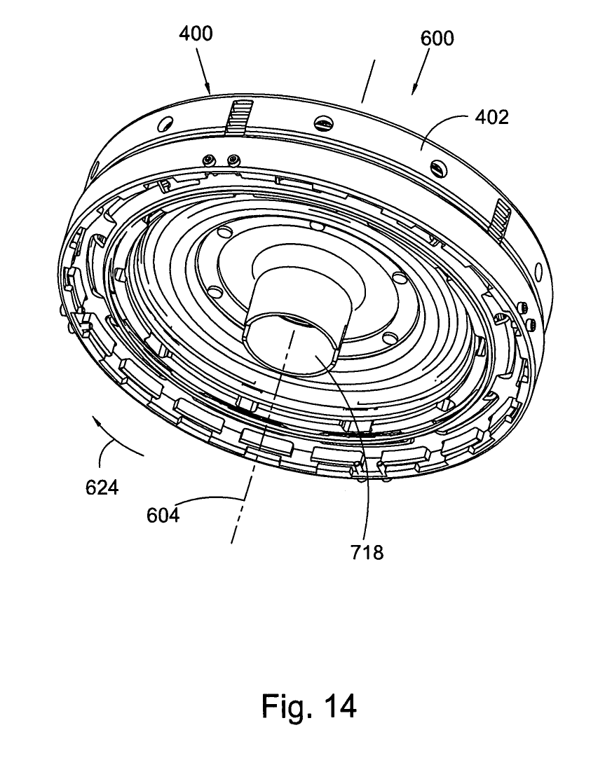

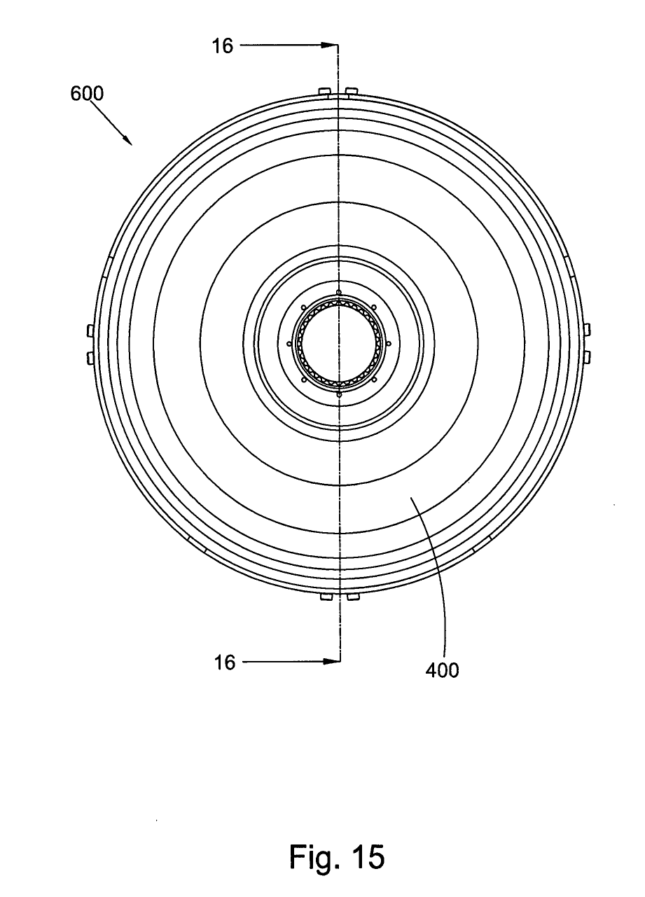

FIG. 14 is a perspective view of dual clutch assembly 600 with spring plates removed and including the clutch housings of FIGS. 12 and 13. FIGS. 12 through 14 show clutch housing and a clutch assembly similar in function to the housings and clutch assembly shown in FIGS. 1 through 3. However, whereas the housings in FIGS. 1 and 2 are stamped, the housings in FIGS. 12 and 13 are machined.

FIG. 15 is a bottom view of the assembly of FIG. 14.

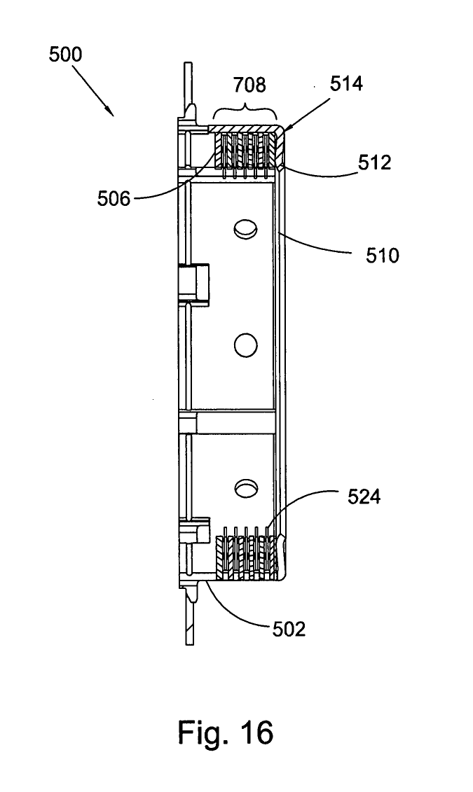

FIG. 16 is a partial cross-sectional view of inner housing 500 and respective clutch plates of FIG. 15 along line 16-16 in FIG. 15.

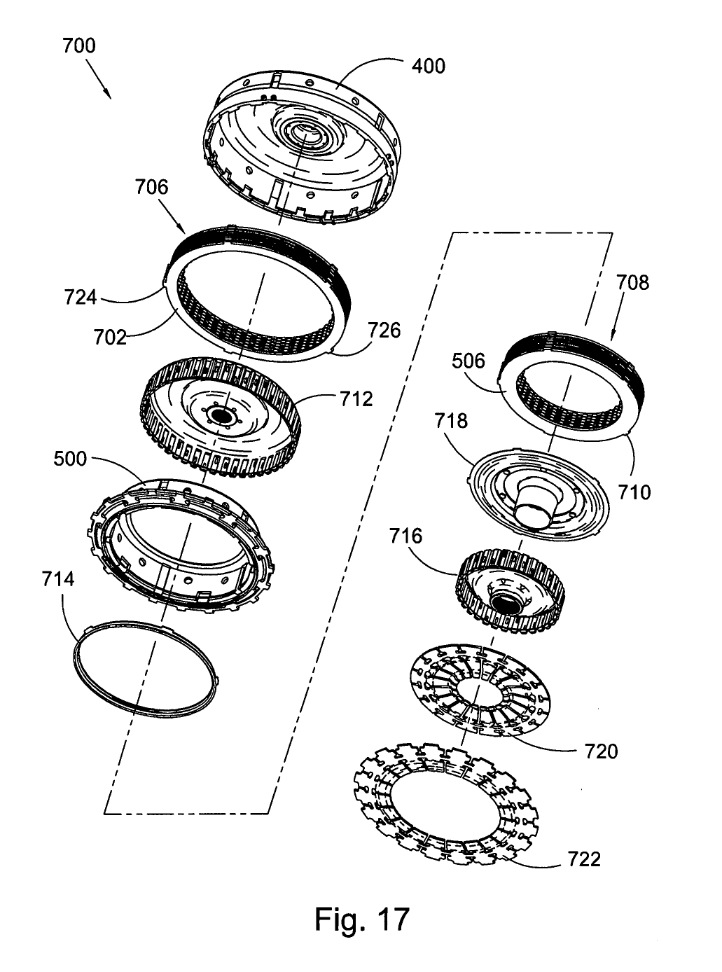

FIG. 17 is an exploded view of present invention dual clutch assembly 700.

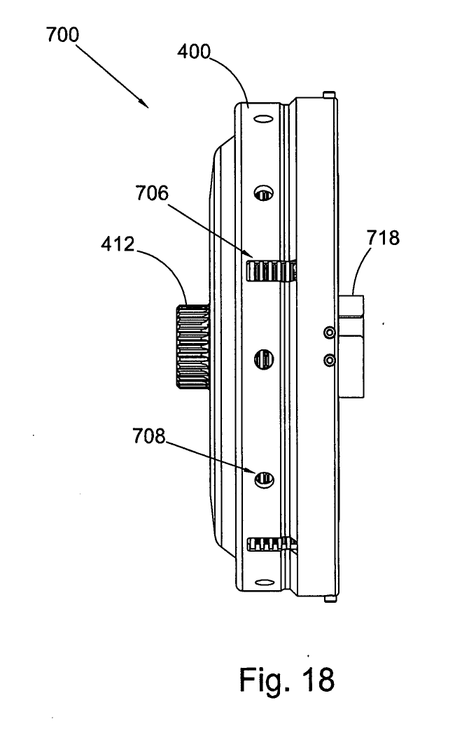

FIG. 18 is a side view of the assembly of FIG. 17. The following should be viewed in light of FIGS. 12 through 18. In general, the descriptions of housings 10 and 100 are applicable to housings 400 and 500, respectively. In particular, the descriptions of housing walls, slots, and slot heights and widths in the description of FIGS. 1 through 11 are applicable to walls 402 and 502 and slots 404 and 504, respectively in FIGS. 12 and 13. It should be understood that walls 402 and 502 are not limited to the shape shown in the figures and that other shapes for the walls are included within the spirit and scope of the invention as claimed.

The arrangement of housings 400 and 500 with respect to clutch plate packs is similar to that described above for housings 10 and 100 and packs 44 and 144, respectively. For example, slots 404 and 504 are arranged to accept clutch plates 702 and 506, respectively, from a clutch assembly. That is, at least a portion of plates 506 and 702 are disposed within slots 504 and 404, respectively. Slots 404 and 504 include openings 410 and 508, respectively. The openings are provided to enable plates 506 and 702 to be inserted into slots 504 and 404, respectively, without bending or distorting the plates.

End wall or lip 510 of housing 500 is arranged so that plates 506 contact the wall. In some aspects, clutch plate stop 512 is formed in wall 510 to engage plates 506. Stop 512 extends above wall 502, forming slot 514 between plates 506 and wall 510. Wall 510 is shown as integral to wall 502, however, it should be understood that other configurations of walls 502 and 510 are possible. In some aspects, end wall 412 also is formed with a stop and forms a slot between plates 702 and the stop, similar in function to the stop and associated slot for housing 10. Other cross-sectional shapes and configurations for walls 412 and 510 are possible.

Although in general, two or more slots 404 or 504 are preferred, any number of slots 404 or 504 is possible and such number of slots is included within the spirit and scope of the invention as claimed. Also, the present invention is not limited to any particular configuration or spacing of slots 404 or 504. In general, walls 402 and 502 and slots 404 and 504, respectively are parallel to axis 604. The discussion of packs 44 and 144 in the descriptions of FIGS. 1-11 is applicable to packs 706 and 708, respectively. It should be understood that the present invention is not limited to use with the number and configuration of plates shown for packs 706 and 708.

Returning to FIG. 12, in some aspects, housing 400 includes hub 414. The discussion regarding hub 40 the descriptions of FIGS. 1-11 is applicable to hub 414. End wall 412 extends to hub 414 and is connected by welding, or any means known in the art, for example, rivets. In particular, laser welding can be used.

FIG. 16 illustrates the stacking of pack 708 in housing 500. In general, the description regarding clutch plates with respect to housing 100 is applicable to housing 500 and pack 708. Tabs 710 extend from the outer circumference of plates 506 and are received in slots 504. In general, tabs 710 correspond in number, location, shape, and configuration to slots 504. That is, each tab 710 corresponds to a respective slot 504. However, it should be understood that other configurations of slots are included within the spirit and scope of the invention as claimed. The discussion of clutch plates, slots, and stacking in the description of FIGS. 5 and 6 is applicable to housing 400 and pack 706.

To form assembly 600, pack 706 is stacked in housing 400 and carrier ring 712 and flow dam/fulcrum 714 are engaged in housing 400. Pack 708 is stacked in housing 500 and flow dam/fulcrum 714, carrier ring 716, and pump driver/fulcrum 718 are inserted. Housing 500 is attached to housing 400. Plate spring 720 is installed to engage pack 708 and plate spring 722 is installed to engage pack 706. However, it should be understood that the present invention is not limited to use with the number, type, and configuration of components shown in FIG. 17 and other number, type, and configuration of components can be used with the present invention.

When torque is applied to hub 414 in direction 624, housing 400 moves in direction 624 and plates 702 engage housing 400, in particular, wall 402. Specifically, edges 418 of slots 404, formed by a portion of wall 402, engage edges 724 of tabs 726, rotating plates 702 in direction 624. Torque is transferred to housing 500. In like manner, edges 522 of slots 504 engage tabs 710, rotating plates 506 in direction 624. In a neutral state (no external pressure is applied to springs 720 and 722), plates 702 are not engaged with the remaining plates in pack 706 and plates 506 are not engaged with plates 524. For example, plates 506 are free to rotate with minimal or no contact with plates 524. When force is applied to spring 722, the plates in pack 706 are brought into frictional contact and rotate together, transferring the torque to carrier ring 712. When force is applied to spring 720, plates 506 and 524 are brought into frictional contact and rotate together, transferring the torque to carrier ring 716. In some aspects, additional openings in housings 400 and 500, for example openings 420 and 526, respectively, are included to provide passage of cooling fluids. It should be understood that assembly 600 also can be moved in a direction opposite direction 624.

Present invention clutch housings have been shown in a dual clutch assembly in FIGS. 9 and 17. However, it should be understood that present invention clutch housings are not limited to dual clutch assemblies. For example, a present invention clutch housing can be used in a single clutch arrangement (not shown), for example, in a launch clutch.

It should be understood that any means known in the art can be used to adjust the clutch assemblies shown in the figures. In addition, in some aspects, the method described in the commonly assigned United States Provisional Patent Application titled “DUAL CLUTCH PACK DUAL OPERATING CLUTCH AND METHOD FOR ADJUSTING SAME,” inventors Uhler et al., filed on the same day as the present application, can be used.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A clutch housing, comprising:
a substantially cylindrical housing wall; and,
at least one opening in said housing wall, said at least one opening operatively arranged to accept at least a portion of a clutch plate in a clutch assembly.

2. The housing of claim 1 further comprising: a longitudinal axis and wherein said at least one opening further comprises at least one slot aligned substantially parallel to said axis.

3. The housing of claim 1 wherein said housing wall further comprises an end and said at least one opening is in communication with said end.

4. The housing of claim 3 wherein said housing wall further comprises a radial off-set proximate said end.

5. The housing of claim 1 wherein said housing is an inner clutch housing for said assembly.

6. The housing of claim 1 wherein said housing is an outer clutch housing for said assembly.

7. The housing of claim 1 wherein said housing is stamped.

8. The housing of claim 1 wherein said housing is machined.

9. A clutch assembly, comprising:
a clutch housing having at least one opening; and,
at least a portion of a clutch plate disposed in said at least one opening.

10. The clutch assembly of claim 9 further comprising: a longitudinal axis and wherein said clutch housing further comprises a cylindrically-shaped housing wall, said at least one opening is disposed in said housing wall, and said at least one opening comprises at least one slot aligned substantially parallel to said axis.

11. The clutch assembly of claim 10 wherein said housing wall comprises an edge proximate at least a portion of said at least one opening and said clutch housing is arranged so that said at least a portion of said clutch plate contacts said edge when torque is applied to said clutch housing.

12. The clutch assembly of claim 9 wherein said clutch housing is an inner clutch housing.

13. The clutch assembly of claim 9 wherein said clutch housing is an outer clutch housing.

14. A dual clutch assembly, comprising:
an outer clutch housing having at least one first opening; and,
an inner clutch housing having at least one second opening, where said inner housing is fastened to said outer housing and said at least one first and second openings are operatively arranged to accept at least a portion of first and second clutch plates, respectively, for a clutch assembly.

15. A method of transferring torque from a clutch housing to a clutch plate, comprising the steps of:
forming at least one opening in a substantially cylindrical housing wall for a clutch housing; and,
disposing at least a portion of at least one clutch plate for a clutch assembly in said at least one opening.

16. The method of claim 15 wherein said housing wall further comprises an end and a portion of said at least one opening is in communication with said end; and, said method further comprising:
inserting said at least one clutch plate through said portion.

17. The method of claim 15 wherein disposing at least a portion of at least one clutch plate in said at least one opening further comprises stacking said at least a portion of at least one clutch plate in said at least one opening.

18. The method of claim 15 wherein said housing wall comprises an edge formed by said at least one opening; and, said method further comprising:
engaging said at least a portion of at least one clutch plate with said edge.

19. The method of claim 15 wherein said clutch housing is an inner clutch housing for said assembly.

20. The method of claim 15 wherein said clutch housing is an outer clutch housing for said assembly.

21. The method of claim 15 further comprising: stamping or machining said housing.
